(19) United States
(12) Patent Application Publication
(10) Pub. No.: US 2010/0208830 A1
(43) Pub. Date: Aug. 19, 2010

(54) Video Decoder

(75) Inventors: Danny D. Lowe, Calgary (CA); Don Lafont, Calgary (CA); Kevin Miles Greenwood, Calgary (CA); Ray E. Lehtiniemi, Calgary (CA); David James Lewis, Calgary (CA)

Correspondence Address: FULBRIGHT & JAWORSKI L.L.P, 2200 ROSS AVENUE, SUITE 2800, DALLAS, TX, 75201-2784, US

(73) Assignee: Headplay (Barbados) Inc., Bridgetown (BB)

(21) Appl. No.: 12/638,703

(22) Filed: Dec. 15, 2009

Related U.S. Application Data
(60) Provisional application No. 61/203,104, filed on Dec. 18, 2008.

(51) Int. Cl. H04N 7/26

(52) U.S. Cl. 375/240.25; 375/E07.027

(57) ABSTRACT

The present invention is directed to a system and method which allows highly compressed data files to be expanded in a standalone decoder having an output at least 80 times larger than the compressed input. In one embodiment, a universally available interface is used to transport encoded media from a host PC to a decoder external to the PC for expansion and presentation as a HD display image. In one embodiment, a USB port of the user's PC (or other storage device) is used to transport data at a rate of between 0.3 Mbit/sec and 5 Mbits/sec for expansion into a robust HD signal of up to about 3Gbits/sec or higher. In other embodiments, provision is made for reducing the decompressed expanded data file to below 480 Mbits/sec so as to accommodate retransport of the decompressed file back to the PC or storage device for temporary storage or display.

### CROSS-REFERENCE TO RELATED APPLICATIONS

This Application claims the benefit of U.S. Provisional Application 61/203,104 filed on Dec. 18, 2008, the disclosure of which is incorporated herein by reference.

### TECHNICAL FIELD

This disclosure relates to video decoders in general and more specifically to a video decoder that is compatible with personal computers and even more specifically to a video decoder that can handle highly coded media over bandwidth-limited physical channels.

### BACKGROUND OF THE INVENTION

It is well-known that in order to deliver large data files, such as a video file of a movie, over a given communication channel the bandwidth of the channel determines the maximum rate at which the file can be received from the source (such as a cable provider head end) to a receiver (such as a cable TV user). A transmission medium, such as a coaxial cable or a wireless protocol, has finite bandwidth that must be shared among all the video files that are simultaneously using that medium. Thus, the more bandwidth one data file requires for transmission from point A to point B over the medium, the fewer the number of different data files that can be transmitted over a given period of time.

One system for reducing the size of a video data file, and thereby the bandwidth required for its transmission and reception, is to compress the size of the file before it is transmitted and then to decompress the file at the receiver. While video compression techniques have advanced greatly over the years, some data (and the information content of that data) are usually permanently lost during the compression/decompression process. When video data files are transmitted in a compressed format this “lost” data results in artifacts in the displayed video that may be visible to the viewer. As the need for more channels increases, the tendency is to increase the extent to which each video file is compressed so as to preserve bandwidth since it is not practical to continually increase transmission medium bandwidth. However, a point is reached where the artifacts become visibly objectionable.

The problem of visibly objectionable artifacts is compounded because the video file may have undergone more than one compression/decompression cycle as well as previous color mixes or re-sizes (each of which can add artifacts to the video) prior to the transmission of the file to the ultimate viewer. Thus, it is possible that a provider (a cable company) could compress a video file to an extent that is acceptable for the case of original undistorted videos but unacceptable for videos that have pre-existing distortion artifacts.

To put the problem in perspective, it must be remembered that each pixel on a screen is made up of three color components. A typical viewing quality might be 8 data bits per color or 24 bits per pixel. With a high definition viewing screen there easily could be over a million pixels per frame. Each pixel must be written to the display once per frame at a frame rate of over 24 frames per second. The H264 (MPEG 4) video compression protocol typically compresses the 24 bits per pixel down to less than 1/20th of a bit per pixel, corresponding to a compression factor of approximately 500 (20×24=480). However, at this level of compression the artifacts in the uncompressed H264 video are typically both visible and objectionable.

The most serious objectionable artifacts of compression at this level are in the form of small rectangular blocks that typically vary with time, size and orientation in ways that depend on the local spatial-temporal characteristics of the video scene. In particular, the nature of the artifact blocks depends upon the local motions of objects in the video scene and on the amount of spatial detail that those objects contain. As the compression ratio is increased for a particular video, MPEG-based video encoders allocate progressively fewer bits to the so-called quantized basis functions that represent the intensities of the pixels within each block. This is so because the intensity (for example, color depth or color shading) is not as important to the human vision system (HVS) as is the detail pertaining to, for example, the details of moving objects. In attempting to retain and track the motion of spatially-detailed regions of a scene, as demanded by the HVS, the encoder eventually allocates a constant (or almost constant) intensity to each block and it is this block-artifact that is usually the most visually objectionable. It has been estimated that adjacent artifact blocks that differ in relative uniform intensity by greater than 3% are visible and objectionable. Large regions of many frames contain such artifacts.

In terms of the intensity difference between the compressed and uncompressed versions of a video, the blocky regions may not be the largest contributors to a mathematical metric of overall distortion. There is typically greater mathematical distortion in the detailed regions of a video but the HVS does not perceive that distortion as readily as it perceives the block artifacts. In particular, the HVS is highly-sensitive to the horizontal and vertical discontinuities of intensity at the edges of adjacent block artifacts in the large open regions of a video scene. Thus, since the HVS has evolved to be sensitive to edges it therefore unfortunately recognizes the edges created by block artifacts in much the same way as it recognizes the legitimate edges of objects.

Discussed herein are very effective methods for removing the undesired artifacts and for compressing the resulting video into data formats that can be easily transported to conserve bandwidth. However, assume that such data, for example a movie that is stored in compressed format on a personal device, such as a PC, is to be played (viewed) by a user on a TV. Assume also that the viewer wants the picture to be in high definition (HD) format, such as, 480p, 576p, 720p, 1080i, 1080p, 2K, 2160p, 4K, 2540p, 4320p. This then would require transporting in excess of 746 Mbits per second over a connector from the PC to the TV. Problems exist, however, in that the typical connection to/from a PC is currently the USB port which has a specified bandwidth of 400 Mbits per second for USB 2. In addition, there is a practical limitation of 300 Mbits/sec or higher, but in some situations the bandwidth can be 480 Mbits/sec.

### BRIEF SUMMARY OF THE INVENTION

The present invention is directed to a system and method which allows highly compressed data files to be expanded in a standalone decoder having an output at least 80 times larger than the compressed input. In one embodiment, a universally available interface is used to transport encoded media from a host PC to a decoder external to the PC for expansion and presentation as a HD display image. In one embodiment, a USB port of the user's PC (or other storage device) is used to transport data at a rate of between 0.3 Mbit/sec and 5 Mbits/sec for expansion into a robust HD signal of up to 3Gbits/sec or higher. In other embodiments, provision is made for reducing the decompressed expanded data file to below 480 Mbits/sec so as to accommodate retransport of the decompressed file back to the PC or storage device for temporary storage or display.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a diagram of one embodiment of a decoder for use with a port of a PC; and

FIG. 2 is a diagram of one embodiment of a host device, such as a PC.

### DETAILED DESCRIPTION OF THE INVENTION

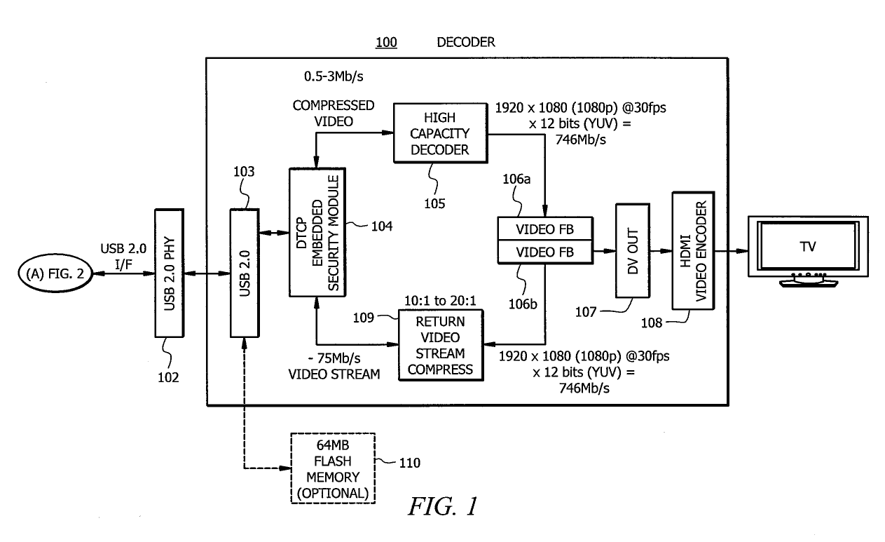

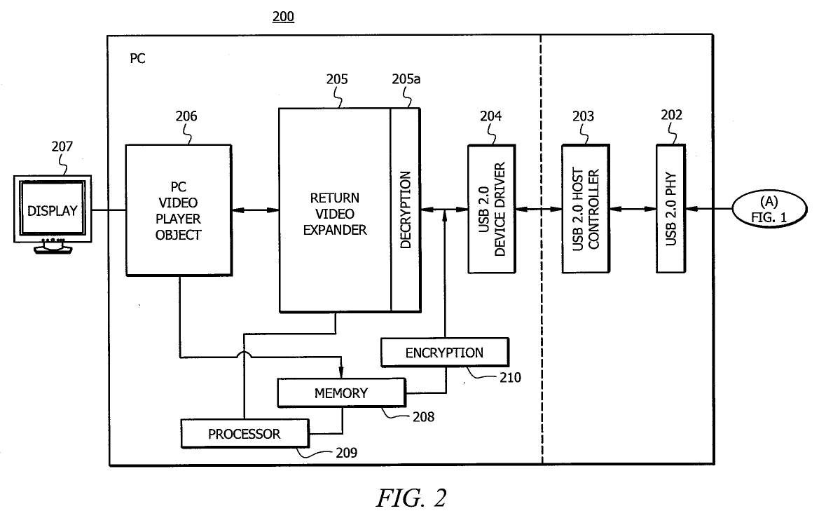

FIG. 1 is a diagram of one embodiment 100 of a decoder for use with a port of a PC, such as the PC shown in FIG. 2. In the embodiment shown, decoder 100 is hand-held and can be used to perform decoding external to a PC or TV, perhaps as a retrofit operation. Note that the PC can be any host device capable of storing data and retrieving that stored data over a universally compatible connection, such as a USB connection. In this embodiment, the USB connection must be a host port or On the Go (OTG) and not simply a USB client device port. The host device can also be any device that has a USB port, a memory, a processor and possibly a screen, such as, a mobile phone or a PDA or even a media playing device like an iPhone. Universal compatibly means that both the physical aspects of the interface as well as the signal processing aspects of the interface adhere to a standard that is used across a plurality of devices and device types.

Within the decoder the hardware, software and firmware could be constructed as a Field Programmable Gate Array (FPGA), a Gate Array (GA), an Application Specific Integrated Circuit (ASIC) or a combination thereof, or by using any other combination of elements. The fundamentals of decoder 100 are physical USB electrical connector 102 with its controller 103, high capacity decoder 105, video buffers 106A and 106B, digital video controller 107 and HDMI encoder 108. Also, included in the decoder, is compressor 109 which reduces the data amount in the return signal to a point that complies with the requirements of the USB connector (under 300 Mbits/sec). Compressor 109 has the ability to recompress the results of high capacity decoder 105 in whatever amount is necessary in order to pass it back across the USB bus.

In addition to what is shown, the decoder has theft protection to prevent people for gaining unauthorized access to media. This is shown in DTCP encryption block 104 which allows for encryption and decryption of the video files as they move in and out of the USB port. In this embodiment, we show a DTCP block however any type of encryption block can be used.

In operation, highly compressed video streams into the USB connector from the host device (FIG. 2) over cable A and passes through USB core 103 and is decrypted by block 104 and then passes to high capacity decoder 105. The high compression can be performed by any method or system that can achieve such high compression, ideally in transmission range of under 10 Mbits/sec and even as low as 0.3 Mbit/sec to 3 Mbits/sec. Indeed, in some embodiments the high compression transmission range is under 0.3 Mbit/sec. Methods for achieving such compression and decompression (decoding) are shown in U.S. patent application Ser. No. 12/176,371 filed Jul. 19, 2008 entitled “SYSTEMS AND METHODS FOR IMPROVING THE QUALITY OF COMPRESSED VIDEO SIGNALS BY SMOOTHING BLOCK ARTIFACTS”; U.S. patent application Ser. No. 12/176,372 filed Jul. 19, 2008 entitled “SYSTEM AND METHOD FOR IMPROVING THE QUALITY OF COMPRESSED VIDEO SIGNALS BY SMOOTHING THE ENTIRE FRAME AND OVERLAYING PRESERVED DETAIL”; U.S. patent application Ser. No. 12/176,374 filed Jul. 19, 2008 entitled “SYSTEMS AND METHODS FOR HIGHLY EFFICIENT VIDEO COMPRESSION USING SELECTIVE RETENTION OF RELEVANT VISUAL DETAIL”; and U.S. patent application Ser. No. 12/333,708 filed Dec. 12, 2008 entitled “SYSTEMS AND METHODS FOR DEBLOCKING SEQUENTIAL IMAGES BY DETERMINING PIXEL INTENSITIES BASED ON LOCAL STATISTICAL MEASURES”; all of the above-identified applications are hereby incorporated by reference herein.

Decoder 105 decompresses the highly compressed video, for example, as taught in the above-identified patent applications and the uncompressed video data is streamed to buffers 106A and 106B. Any number of buffers (including zero) can be used as desired to maintain a smooth data transmission flow. At this point, the decoder output data transmission rate for this embodiment is in the range of 800 Mbits/sec which will yield a HDTV image. However, the output could be in the range of 3Gbits/sec and above, if desired. If the output is recompressed then the output would be typically under 1 Gbit/sec. The dual buffers shown are a typical double buffering implementation that allows the decoder to output one frame buffer while working on a second frame buffer and pulling it into another stage of the pipeline. However, one could reduce or eliminate the requirements for double buffering depending on the algorithms and implementations of decoder 105 and compressor 109. In this embodiment, the data passes out to digital video processor 107 and in conjunction with HDMI control 108 conditions the video for HD output to a TV or other display device. Note that any output format can be used by simply replacing, or adding, another processor type to the output of buffers 106A and B.

In situations where it is desired to feed a decoded signal back over cable A the data rate must be reduced to comply with the limitations of the bidirectional data transfer capability of the USB interface. In order to accomplish such a reduction, the decompressed data from buffers 106A and 106B is passed through compressor 109 which operates to reduce the data rate to an acceptable range. In the embodiment being discussed, compressed output from compressor 109 is sent to encryption control 104 and then via USB 103, 102 and cable A to the host device. Note that in some situations encryption in one or both directions may not be necessary and in those situations encryption control 104 can be eliminated from the path or even from the device. Also note that if and when USB interfaces can handle higher throughput, the recompression, if any, can be less.

In the embodiment shown in FIG. 1, the various elements have processing built therein but a processor (not shown) common to all elements of decoder 100 could be used. The decoding and compression and other functions of the decoder can be controlled by hardware, software (including code running on a processor) or using a combination of hardware, software and firmware.

FIG. 2 is a diagram of one embodiment 200 of a host device, such as a PC. It should be noted that the host device is not limited to a PC and may include other devices such as set top box, mobile internet device and cellular phone. As shown, compressed data can be stored in a memory, such as memory 208, and when desired a video file can be retrieved from the memory under control of processor 209. The retrieved code is then encrypted by encryption control 210 and passed over the USB interface and cable A under control of USB control elements 204, 203 and 202. Since this data is in highly compressed format, the data is in the transmission range of 0.5 Mbit/sec to 3 MBits/sec (but could be up to 20 Mbits/sec), well within the range of the USB interface.

When the decompressed data returns to the host device via the USB connection, either for storage, or to be viewed by a user at the host device, the data is decrypted by device 205A (or if desired, by device 210) and expanded (if necessary) by expander control to remove the compression introduced by compressor 109 of the decoder. The output from the expander is presented to a video conditioner circuit, such as circuit 206, to condition the data for presentation to a user via display 207 and/or for storage in the expanded format in memory 208. Circuit 206 could be a frame buffer, such as a graphics card, typically used in the video electronics within the system on the host device.

Note that storage of the returned expanded data file can be accomplished either before or after expansion by circuit 205, if desired.

In the embodiment shown in FIG. 2, the various elements of host 200 are controlled by a common processor but the various elements could have individual processors if desired. The various elements of the host can be controlled by hardware, software (including code running on a processor) or using a combination of hardware, software and firmware.

In some situation there is no need to return the decoded video to the host and in those situations there is no need for compressor circuitry 109 (FIG. 1). If desired, security can be implemented on the output to the TV but such security at this point is not now typically used. Note that while HDMI is shown, as discussed above, any output can be generated and if desired, one or more outputs can be from the output of circuit 107 so that a user can simply plug a TV or other monitor directly into any one of a number of different outputs.

In other situations, the only viewing of the video file will be via the host and in those situations there is not a need for the TV output from the decoder. However, both circuits are shown for situations where it is desired to have a more universal adaptor to accommodate both situations. Note also, that the decompressed signal can be combined with other signals, such as menus or other data particularly at the host, so that the user can have a full range of options.

In situations where USB is not available as an interface, the connection could be made for any other type of interface since the output from the host is in a relatively low data transmission range. One example would be to use the PCI interface. Other interfaces may be used in embodiments of the invention and include PCI Express, ethernet and SATA. In some situations it might be desired for a user to be able to store the decoded data file on an external memory. In this situation, a USB port could be provided to allow a user to insert a flash memory, such as memory 110, to the decoder and then be able to store the decoded data file. In some situations, the flash memory could act as the host device to provide the input to the decoder. In such a situation, the data from the flash drive could be stored on the decoder in a memory, not shown, and then the decoder connected to a PC. The connection to the PC could be eliminated, but the PC connection is a good place to obtain synchronization for the USB interface as well as to supply power (which could be supplied externally, if desired). Also, in some situations it might be desirable to use some of the computing capability of the PC across the USB interface to the decoder. This then reduces the computing power required on the decoder.

It should be noted that while the compressed video file is shown as being contained in a memory within the host, the data file can be streamed from the Internet, or other data network, perhaps at a data rate at or below 10 Mbits/sec, and the streaming data could then be sent directly to the decoder, via the USB interface, for decoding.

In one alternate embodiment, the “host” could be a TV set with a USB (or any other universally accepted) interface. In such a situation, the highly compressed streaming data from the Internet (or other data network) could be sent directly to the TV set and the decoder (dongle) plugged into the interface. In such a situation, decoding of the highly compressed data would occur outside of the TV in the dongle and the HD signal then could be externally fed back to the TV via the HDMI output of the dongle or it could be sent back via the USB interface if a lower fidelity signal is acceptable.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A decoder for use with a host device, said decoder comprising:
an interface for connecting said decoder to a particular host device;
apparatus for decoding a highly compressed video file resident on said particular host device and passed from said host device to said decoder via said interface; and
apparatus for presenting said decoded video file to at least one device selected from the following: HDTV via a direct output, digital interface to a display, analog video interface to a display, said host device via said interface.

2. The decoder of claim 1 wherein said highly compressed video file is in a transmission range under 20 Mbits/sec and said decoded video file is in a transmission range of approximately 3 Gbits/sec.

3. The decoder of claim 2 wherein said video file to said host device is in the transmission range below 480 Mbits/sec.

4. The decoder of claim 3 wherein said transmission via said interface is encrypted.

5. The decoder of claim 3 further comprising:
an input for receiving a user supplied video file compressed to under a transmission rate of 20 Mbits/sec.

6. The decoder of claim 3 further comprising:
a compressor for reducing said 3 Gbits/sec to under 480 Mbits/sec for transmission to said host device across said interface.

7. The decoder of claim 3 wherein said interface is selected from a USB, PCI, PCI Express, ethernet, SATA, interface and said host device is selected from PC, set top box, mobile internet device, cellular phone.

8. The decoder of claim 1 wherein said highly compressed video file is in a transmission range from about 0.3 Mbit/sec to 5 Mbits/sec and said decoded video file is in a transmission range of up to 3 Gbits/sec.

9. The decoder of claim 8 wherein said video file to said host device is in the transmission range below 1 Gbits/sec when recompressed and greater than 3Gbits/sec when not recompressed.

10. The decoder of claim 9 further comprising:
a compressor for reducing said 3 Gbits/sec to under 1 Gbits/sec for transmission to said host device across said interface.

11. A method for decompressing highly compressed video data, said method comprising:
inserting a removable decoder into a universal interface port of a host device;
streaming a highly compressed video file via said universal interface from said host device to said decoder, and
decoding said streaming file within said decoder to obtain a HD quality video output transmission data stream.

12. The method of claim 11 wherein said host device is a computer and said interface is a USB port of said computer.

13. The method of claim 11 wherein said host device is selected from TV, computer, set top box, mobile internet device, cellular phone and wherein said HD quality output is provided to said TV.

14. The method of claim 11 wherein said streaming from said host device to said decoder is at a transmission rate of under 5 Mbits/sec and wherein said HD quality data stream has a transmission rate in the range greater than 480 Mbits/sec.

15. The method of claim 11 further comprising;
decrypting said streaming file in said decoder prior to said decoding.

16. The method of claim 11 further comprising:
reducing said transmission rate of said HD quality data stream an amount sufficient to stream said HD quality data stream back to said host via said interface.

17. The method of claim 16 wherein said reduced amount is in the range of 2:1 to 50:1.

18. The method of claim 17 further comprising:
encrypting said reduced transmission rate data stream prior to streaming said data to said host.

19. A system comprising:
a host device selected from PC, set top box, mobile internet device, cellular phone; and
a decoder communicatively connected to said host device wherein said decoder comprises:
apparatus for decoding a highly compressed video file resident on said particular host device and passed from said host device to said decoder; and
apparatus for presenting said decoded video file to at least one device selected from the following: HDTV via a direct output, digital interface to a display, analog video interface to a display, said host device via said interface.

20. The system of claim 19 wherein said highly compressed video file is in a transmission range from about 0.3 Mbit/sec to 5 Mbits/sec and said decoded video file is in a transmission range of up to 3 Gbits/sec.
